(19) United States
(12) Patent Application Publication
(10) Pub. No.: US 2013/0282510 A1
(43) Pub. Date: Oct. 24, 2013

(54) Splitting of User-Lists

(71) Applicants: Raghava Hassan Nanjunda Swamy, Sunnyvale, CA (US); Xun Liu, Foster City, CA (US); Anurag Agarwal, Sunnyvale, CA (US); Oren Eli Zamir, Los Altos, CA (US)

(72) Inventors: Raghava Hassan Nanjunda Swamy, Sunnyvale, CA (US); Xun Liu, Foster City, CA (US); Anurag Agarwal, Sunnyvale, CA (US); Oren Eli Zamir, Los Altos, CA (US)

(73) Assignee: GOOGLE INC., Mountain View, CA (US)

(21) Appl. No.: 13/620,501

(22) Filed: Sep. 14, 2012

(30) Foreign Application Priority Data
Apr. 18, 2012 (IL) 219244

(51) Int. Cl. G06F 17/30; G06Q 30/00

(52) U.S. Cl. 705/26.4; 707/756; 707/E17.005

(57) ABSTRACT

Systems and techniques are described for splitting user-lists. A described technique includes obtaining a master user-list, the master user-list including object identifiers that are respectively associated with web clients; obtaining a splitting factor that controls a splitting of the master user-list; creating a reduced user-list from the master user-list based on the splitting factor such that the reduced user-list maintains a statistical fidelity of the master user-list, the reduced user-list including fewer than all of the object identifiers included in the master user-list; and providing the reduced user-list.

### TECHNICAL FIELD

This patent document relates to user-list splitting and determining aspects associated with displaying content via a network such as the Internet.

### BACKGROUND

Publishers of online resources, such as websites, can optimize the delivery of content items, such as advertisements, to receptive audiences via the Internet. One form of online advertising is advertisement syndication, which allows advertisers to extend their marketing reach by distributing advertisements to additional partners. For example, a third party online publisher can place an advertiser's sponsored content, such as text or image advertisements, on a website with desirable content to help drive online customers to the advertiser's website. An online publisher can use an advertising intermediary that selects and causes advertisements to be displayed on the online publisher's website when rendered on a browser. In some cases, the advertising intermediary can select one or more advertisements that are relevant based on the contents of the online publisher's website.

In online advertising, a business can submit both an ad creative (e.g., a file or other information for use in rendering the ad) with meta-data, such as one or more targeting keywords and a bid, and can have its ad shown to web users in situations where the keywords are relevant. This form of advertising can be very simple, with a small business logging in and running only a handful of ad campaigns with few ad creatives per campaign. It can also be extremely complex, with large ad agencies or advertisers running hundreds of campaigns with thousands of ad creatives, selecting particular web sites to run their ads, and fine-tuning a number of parameters to maximize the effectiveness of the ad campaigns.

Certain companies generate data as part of their operations and certain other companies may desire to have access to that data. For example, an automotive web site may be able to generate data indicating which of its visitors are likely to buy a car in the next six months. This information—that the consumer is actually ready to spend, and not just window shopping—can be quite valuable to the consumer and sellers of automobiles and thus, in turn, can be valuable to a company, such as an on-line publisher, that sells ad space to advertisers promoting automobile sales. In addition, some advertisers, such as a seller of automobiles, may find providing ads or other content items to such users beneficial and may be willing to pay extra for benefiting from the data. For example, the advertiser could determine from the automotive website whether a consumer is interested in big cars or small cars, and the advertiser could select ads appropriately.

### SUMMARY

This document includes systems and techniques related to user-list splitting. According to an aspect of the described systems and techniques, a described technique includes obtaining a master user-list, the master user-list including object identifiers that are respectively associated with web clients; obtaining a splitting factor that controls a splitting of the master user-list; creating a reduced user-list from the master user-list based on the splitting factor such that the reduced user-list maintains a statistical fidelity of the master user-list, the reduced user-list including fewer than all of the object identifiers included in the master user-list; and providing the reduced user-list. Other implementations of this technique include corresponding systems, apparatus, and computer programs encoded on computer storage devices.

These and other implementations can include one or more of the following features. The splitting factor can include a value N. Creating the reduced user-list from the master user-list can include determining hash values for the object identifiers, the hash values being based on respective values of the object identifiers modulo N and using the hash values to select a portion of the object identifiers from the master user-list. The splitting factor can include an integer value K that is greater than one. Creating the reduced user-list from the master user-list can include creating K reduced user-lists based on a division of the object identifiers into K unique portions. The reduced user-lists can include one of the K unique portions, respectively. Creating the reduced user-list from the master user-list can include randomly selecting object identifiers from the master user-list based on the splitting factor and a size of the master user-list. The object identifiers each can include a cookie identifier. The object identifiers each can include an identifier based on a hash of a cookie identifier. Providing the reduced user-list can include offering the reduced user-list for sale to one or more data buyers. Obtaining the splitting factor can include receiving a value via a network, the value being responsive to an input from a data buyer. In some implementations, the master user-list has a statistical distribution of web clients, and the reduced user-list is created to have the same statistical distribution of web clients.

In another aspect, a system for splitting user-lists can include a computer-readable storage device and a processing device. The computer-readable storage device can be configured to store a master user-list. The master user-list can include object identifiers that are respectively associated with web clients. The processing device can be configured to perform operations. The operations can include obtaining a splitting factor that controls a splitting of the master user-list, creating a reduced user-list from the master user-list based on the splitting factor such that the reduced user-list is statistically equivalent to the master user-list, the reduced user-list including fewer than all of the object identifiers included in the master user-list, and providing the reduced user-list.

In another aspect, a computer-readable storage device can be encoded with a computer program for splitting user-lists. The program can include instructions that when executed by data processing apparatus cause the data processing apparatus to perform operations. The operations can include obtaining a master user-list, the master user-list including object identifiers that are respectively associated with web clients; obtaining a splitting factor that controls a splitting of the master user-list; creating a reduced user-list from the master user-list based on the splitting factor such that the reduced user-list maintains a statistical fidelity of the master user-list, the reduced user-list including fewer than all of the object identifiers included in the master user-list; and providing the reduced user-list.

Particular configurations of the subject matter described in this document can be implemented so as to realize one or more of the following potential advantages. A described technique can help a data-seller to split a user-list such that the data-seller can sell a portion of the user-list at a reduced price. A described technique can help a webmaster or a web developer to perform A/B testing, where a baseline sample of a user-list is used for statistical analysis. A described technique can generate reduced user-lists from a master user-list such that the reduced user-lists are statistically equivalent to the master user-list.

Details of one or more implementations of subject matter described in this document are set forth in the accompanying drawings and the description below. Other features, aspects, and advantages will become apparent from the description, the drawings, and the claims.

### BRIEF DESCRIPTION OF THE DRAWINGS

FIG. 1 shows an example of a system for data exchange.

FIG. 2 shows a flowchart of an example process that includes creating a reduced user-list from a master user-list.

FIG. 3 shows a flowchart of an example process that includes hash-based selection of object identifiers to generate a reduced user-list.

FIG. 4 shows a flowchart of an example process that includes generating different reduced user-lists based on hash values.

FIG. 5 shows an example of distributing object identifiers from a maser user-list into three reduced user-lists.

FIG. 6 shows a flowchart of an example process that includes generating a reduced user-list based on random sampling of a master user-list.

Like reference numbers and designations in the various drawings indicate like elements.

### DETAILED DESCRIPTION

Business entities, such as advertisers, publishers, or data-sellers, create and populate user-lists through one or more techniques. Examples of such techniques include pixel firing, bulk upload, logical combinations of lists, and rule based lists. Other techniques are possible. User-lists can include object identifiers, such as a cookie identifier or an encrypted version of a cookie identifier, that are associated with web clients. A cookie identifier can be used to store web client behavior such as web browsing history or preferences indicated by a web client. A web client can be associated with a person or an entity. Further, a web client can refer to a web browser that runs on a device. In some cases, user-lists can grow to include thousands, millions, or more object identifiers. Huge user-lists may be cost prohibitive for some advertisers seeking user lists for distribution of content items. To address this issue, data-sellers may split a user-list and sell a portion of a user-list for a reduced price. In some cases, a business entity splits a user-list to perform A/B testing, where a baseline sample of the user-list is used for statistical analysis.

Splitting a user-list should be performed in such a way that there is no bias in the splitting. For example, a master user-list is split into two reduced user-lists. The reduced user-lists should have similar distributions of object identifier attributes (e.g., similar distribution of geographic origins, similar distribution of web browsing behaviors, or similar distribution of user genders if known) with each other and the master user-list. Techniques for splitting user-lists include mutually exclusive sampling, random-function based sampling, or both.

In mutually exclusive sampling, creating a split of the user-list includes providing parameters such as a fractional value that controls a dividing of a user-list, an indication of what portion of the user-list should be returned, or both. In some implementations, the parameters include integers N, and M, where N>M. A splitting technique can include determining a hashed version of an object identifier (e.g., an identifier of a cookie object) within a master user-list, performing a modulo with N on the hashed version, and if the modulus equals M, a reduced user-list is populated with the object identifier, or a representation thereof. Such a technique can help to ensure mutual exclusivity among different fractions of the list. Based on the hash function, the technique can also help to ensure the splitting is not correlated with any other feature of the object identifier, such as a geographic or demographic feature associated with the object identifier.

In random-function based sampling, creating a reduced user-list includes receiving a value K and iterating through a master user-list based on the value k. Iterating through the master user-list can include taking the mod of a hashed version of an object identifier, such as an encrypted cookie identifier, of the master user-list and comparing the hashed version with a random integer variable produced by a random function. The random function can produce random integer variables which can take any value between 1 and k with equal probability. The reduced user-list is populated with the object identifier based on the hashed version equaling the random integer variable.

Data provider systems can share data such as user-lists with a data exchange system. Data provider systems can include mechanisms for generating and splitting user-lists. The data exchange system can provide the user-related data to one or more data consumer (e.g., data buyer) systems, such as advertiser systems. The data exchange system can control how data buyers access the user-related data. In some implementations, data provider systems can employ a user-list generator and splitter to generate a master user-list and one or more reduced user-lists from the master user-list.

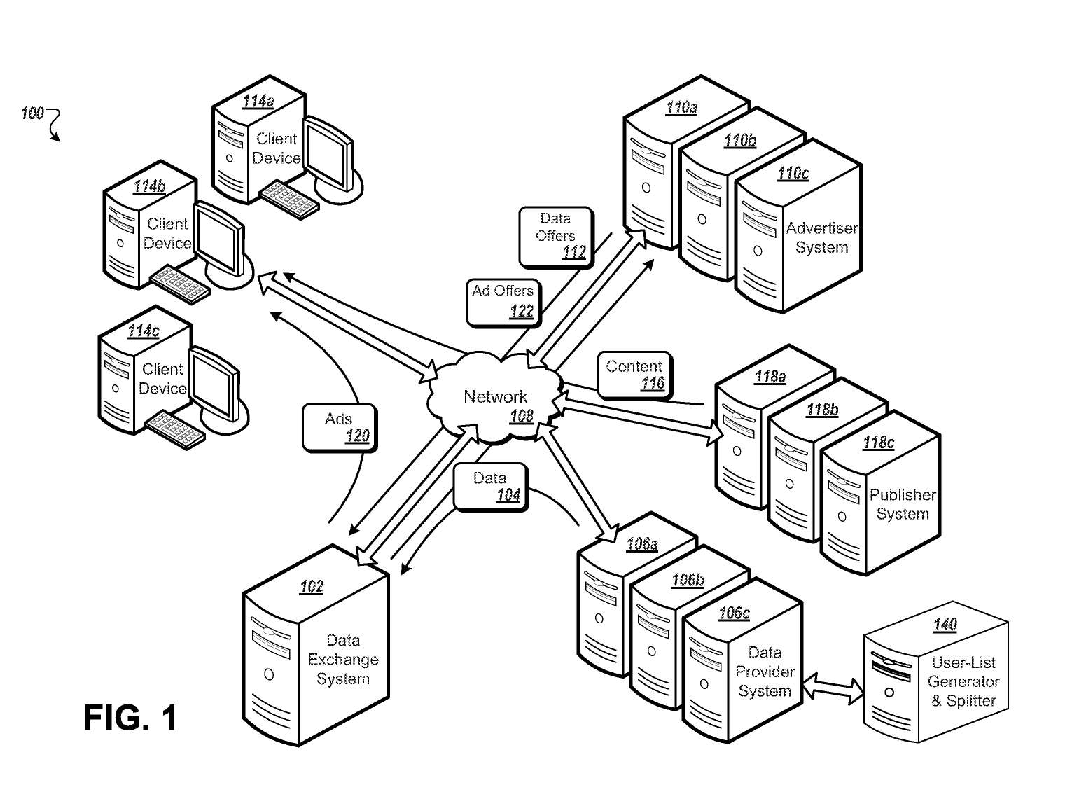

FIG. 1 shows an example system 100 for data exchange. The system 100 includes a data exchange system 102 that receives a plurality of user-related data 104, for example, from one or more data provider systems 106a-c through a network 108, such as the Internet. The system 100 also includes one or more consumers of the user-related data (e.g., one or more advertiser systems 110a-c) that send one or more offers 112 to the data exchange system 102 to access at least a portion of the user-related data 104. The data exchange system 102 selects one or more of the advertiser systems 110a-c and provides (or makes available) the portion of the user-related data 104 to the selected advertiser systems.

The user-related data 104 can include information associated with one or more web clients. For example, the user-related data 104 can include personal preferences indicated by actions of a particular web client, a history of web sites viewed by the web client, or a history of advertisements clicked on or selected by the web client. In some implementations, the user-related data 104 do not include information capable of determining corresponding identities of the web clients associated with the user-related data 104. For example, the user-related data 104 can exclude names, postal addresses, or other information that can be linked to the identities of the web clients.

The data exchange system 102 and/or the data provider system 106a-c can, in some implementations, allow a web client to opt into a data collection service. In some implementations, the data exchange system 102 and/or the data provider system 106a-c can allow a web client represented by the user-related data to opt out of user-related data collection or opt of certain types of data collection (e.g., web site history or advertisement clicks). For example, one or more of the data provider systems 106a-c may use its own identifiers for user-related data and one or more may use an identifier (which may be encrypted) provided by the data exchange system 102. In the case where a web client opts out of data collection through the data exchange system 102 and a data provider uses its own identifiers, the data exchange system 102 can inform the data provider that the web client has opted out of data collection. The data exchange system 102 can inform the data providers of the opt out, for example, using an application program interface (API), e.g., during an API call requesting a transfer of data to the data exchange system 102 or a separate API call.

In some implementations, at least a portion of the user-related data 104 can be gathered offline and then entered/or otherwise provided to one or more of the data provider systems 106a-c and/or the data exchange system 102. For example, user-related data can be written by a person on a questionnaire and then entered into a data provider system by an administrative user.

Alternatively or in addition, at least a portion of the user-related data 104 can be gathered (e.g., automatically) by the data provider systems 106a-c and/or the data exchange system 102. For example, web page requests and other actions, such as clicks on or selections of content (e.g., hyperlinks, images, videos, or advertisements) can be recorded and associated with a unique identifier such as a cookie identifier. The unique identifier can be used as an anonymous representation of the web client associated with the recorded data. In some implementations, the identifier and/or user-related data for a web client can be stored in a cookie at a client computing device operating the web client. The client computing device can then provide the cookie to one or more of the data provider systems 106a-c and/or the data exchange system 102, for example, in a web form submission or web page request.

In some implementations, a data provider system, which can also be a publisher system, sends content to a client computing device. The content can include an inline frame with a source web address of the data exchange system 102 for an advertisement slot or a pixel (e.g., a small web page that is not intended to be seen by the person at the client computing device). The small page can be, for example, an inline frame that is one pixel wide by one pixel in height. The data provider system can pass user-related data to the data exchange system 102 through parameters in the source address of the inline frame.

For example, the Uniform Resource Locator (URL) in the source address of the inline frame can include the following web address and URL parameters: “http://dataexchange.example.com?user_id=123456789&user type=car_buyer.” This URL passes an identifier of the web client and a key-value pair indicating that the web client is of a type that intends to purchase a car. The hyperlink can include other parameters, such as an identifier of the data provider and/or additional key-value pairs for other user-related data. In some implementations, the data exchange system 102 uses the identifier of the data provider in the URL of the inline frame to attribute the user-related data in the URL to the data provider.

The system 100 further includes one or more client computing devices 114a-c that receive a plurality of content 116 from one or more publisher systems 118a-c. For example, the client computing device 114a can receive a news web page from the publisher system 118a, the client computing device 114b can receive a video from the publisher system 118b, and the client computing device 114c can receive a search results web page from the publisher system 118c. In some implementations, one or more of the publisher systems 118a-c can also be data providers and/or advertisers, and one or more of the data provider systems 106a-c can also be advertisers.

The content 116 provided by the publisher systems 118a-c includes one or more content slots (e.g., advertisement slots). An advertisement slot is a space in the content 116 that is available for the placement of an advertisement. For example, a web page can include a side bar or other predefined location with one or more slots for insertion of advertisements. In another example, an advertisement can be inserted at the beginning of or at some other position in a video or audio presentation.

The publisher systems 118a-c provide information to the data exchange system 102 that describes the available advertisement slots. The data exchange system 102 then identifies one or more advertisements 120 to be placed in the advertisement slots. Alternatively, a system separate from the data exchange system 102 can receive the advertisement slot information and identify the advertisements 120 to be placed in the advertisement slots.

In some implementations, the data exchange system 102 receives one or more offers 122 from the advertiser systems 110a-c to place advertisements in the available advertisement slots. In some implementations, the advertiser systems that received the portion of the user-related data 104 base their offers for the advertisement placement on information in the portion of the user-related data 104. For example, an advertiser may specify one or more criteria for placing advertisements. The criteria can include, for example, requiring that the user-related data contain an indication of a particular personal preference or a particular demographic characteristic. In another example, an advertiser may choose to make a higher offer for an advertisement placement than the advertiser would otherwise make if the user-related data associated with the person indicates a particular likelihood that the person will make a certain type of purchase soon.

In the system 100, a user-list generator and splitter 140 can include a computer-readable storage device and a processing device configured to generate a master user-list based on data provided by one or more of the data provider systems 106a-c. The computer-readable storage device includes hardware for storing data such as a master user-list. The processing device can include one or more processor cores and one or more memory structures. The user-list generator and splitter 140 can split the master user-list into one or more reduced user-lists based on a splitting factor provided a system such as the data exchange system 102 or a data provider system 106a-c. A data provider system 106a-c can retrieve one or more reduced user-lists and forwarded them to an advertiser system 110a-c. An advertiser system 110a-c can use a reduced user-list for targeted advertising.

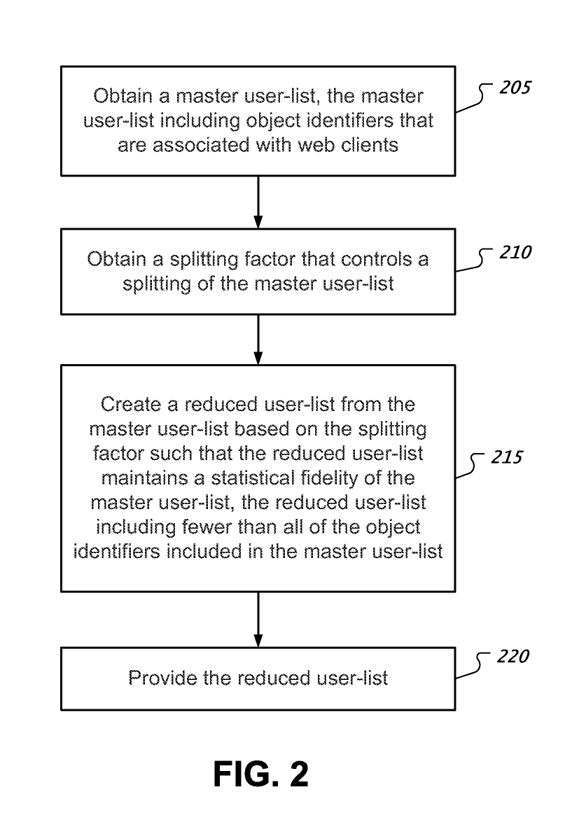

FIG. 2 shows a flowchart of an example process that includes creating a reduced user-list from a master user-list. At 205, the process obtains a master user-list. The master user-list can include object identifiers that are associated with web clients. In some implementations, the object identifiers can be associated with web clients that are operated by an entity or a person. Obtaining a master user-list can include accessing a database server to retrieve a portion or all of a master user-list. In some implementations, an object identifier is a cookie identifier or a hash thereof.

At 210, the process obtains a splitting factor that controls a splitting of the master user-list. Obtaining a splitting factor can include receiving a value via a web-based interface. For example, a web-based interface can request a splitting factor within a webpage, such that an end-user, e.g., a data buyer, enters in a value for the splitting factor. In some implementations, a value for a splitting factor can be provided as an input to an API that invokes this process. In some implementations, the splitting factor is an integer value. For example, a splitting factor of three can cause the process to split the master user-list into three reduced user-lists. In some implementations, the splitting factor is a factional value or a percentage. For example, a splitting factor of 50% can cause the process to create a reduced user-list that is 50% of the size of the master user-list. In some implementations, obtaining a splitting factor can include accessing a stored value or a previously-received value.

At 215, the process creates a reduced user-list from the master user-list based on the splitting factor such that the reduced user-list maintains a statistical fidelity of the master user-list, the reduced user-list including fewer than all of the object identifiers included in the master user-list. Maintaining a statistical fidelity of the master user-list can include creating a reduced user-list that is statistically equivalent to the master user-list. With respect to user-lists, a statistically equivalent representation is where a master user-list and an associated reduced user-list have one or more statistical properties in common. Various examples of statistical properties include mean, standard deviation, or both. Other types of statistical properties are possible. A master user-list, for example, can have a statistical distribution of web clients, and a reduced user-list can be created from the master user-list to have the same statistical distribution as the master-user list. For example, if the ratio of object identifiers associated with a male feature to object identifiers associated with a female feature in the master user-list is 2:1, then the ratio for the reduced user-list should also be 2:1.

Attributing a male or a female feature to an object identifier can be performed by accessing user profile data or by analyzing the web browsing history of a user, for example. In another example, if the ratio of object identifiers associated with California to object identifiers associated with New York is 1:1, then the ratio for the reduced user-list should also be 1:1. In some cases, the likelihood of picking an object identifier associated with a feature of being from a specific state should be the same for both the master user-list and any of the reduced user-lists. However, a reduced user-list could be created having users that are only from a single state or group of states. In some cases, causing a random sampling of entries within a master user-list can result in reduced user-list that is statistically equivalent to the master user-list. Creating a reduced user-list can include generating a document that includes a portion (i.e., at least one, but not all) of the object identifiers included in a master user-list.

In some implementations, creating a reduced user-list from the master user-list, at 215, includes randomly sampling the master user-list. For each object identifier within the master user-list, a decision as to whether to include the object identifier into a reduced user-list can be determined based on an output of a random number generator and the splitting factor. Based on a splitting factor of two, for example, the decision to include is based on an outcome of a digital coin toss.

In some implementations, creating a reduced user-list from the master user-list, at 215, includes using a hash function to select object identifiers from the master user-list. For each object identifier within the master user-list, a decision as to whether to include the object identifier into a reduced user-list can be determined based on an output of a selection function. The selection function can be based on a hash of the object identifier and the splitting factor.

At 220, the process provides the reduced user-list. Providing the reduced user-list can include offering the reduced user-list for sale to one or more data buyers via an electronic data exchange system. Providing a reduced user-list can include sending a document that includes one or more object identifiers. In some implementations, the document is in accordance with a format such as Extensible Markup Language (XML), which is both human-readable and machine-readable. In some implementations, providing the reduced user-list includes sending hash values of the object identifiers included in the reduced user-list to a recipient device via a network connection. In some implementations, providing the reduced user-list includes replacing cookie identifiers with hashes of the cookie identifiers to obscure the cookie identifier.

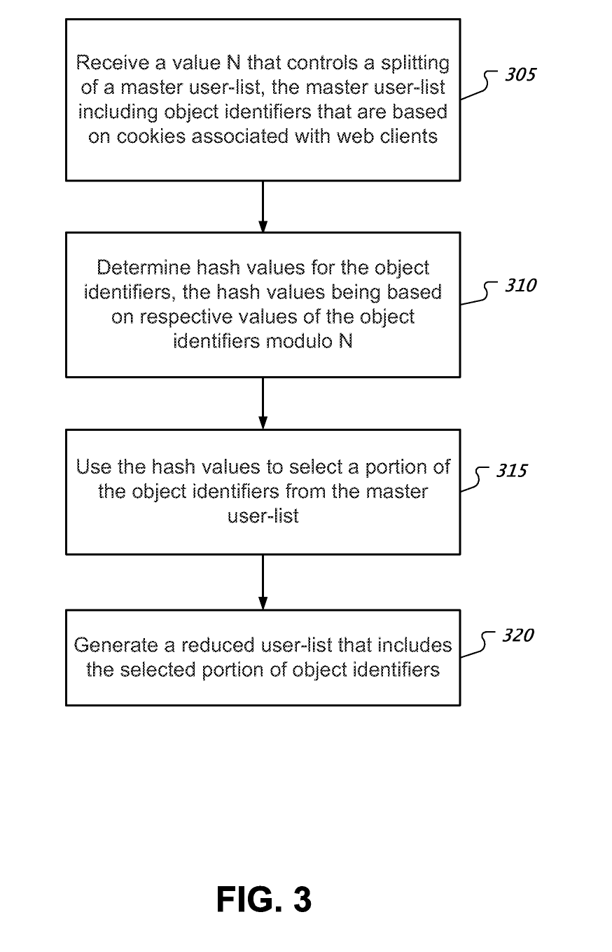

FIG. 3 shows a flowchart of an example process that includes hash-based selection of object identifiers to generate a reduced user-list. At 305, the process receives a value N that controls a splitting of a master user-list. The value N can be an integer value. The master user-list can include object identifiers that are based on cookies associated with web clients. In some implementations, an object identifier includes one or more data fields that provide information associated with an end-user. Various examples of the data fields include cookie value, type of browser, type of hardware device platform, and type of operating system. Other data fields are possible. Web clients can include web-enabled devices such as interactive televisions, mobile phones, laptops, personal computers, web crawlers, or automated content retrieval systems. A type of hardware device platform, for example, could indicate a web-enabled television or a web-enabled mobile phone.

At 310, the process determines hash values for the object identifiers. The hash values can be based on respective values of the object identifiers modulo N. Determining hash values for the object identifiers, for example, can include using a function that outputs the modulus of an input value based on a modulo value, where the modulo value is N and the input value is based on an object identifier. In some implementations, the input value is a cookie value included in an object identifier. In some implementations, the input value is derived from multiple data fields included in an object identifier. For example, the input value can be based on a hash of a concatenation of multiple data fields included in an object identifier.

At 315, the process uses the hash values to select a portion of the object identifiers from the master user-list. At 320, the process generates a reduced user-list that includes the selected portion of object identifiers. The value N can be 3 for a 3-way split. The process can include in the reduced user-list object identifiers that hash to a predetermined value (e.g., x % N==1). Object identifiers that hash to values other than the predetermined value can be skipped or included in another reduced user-list.

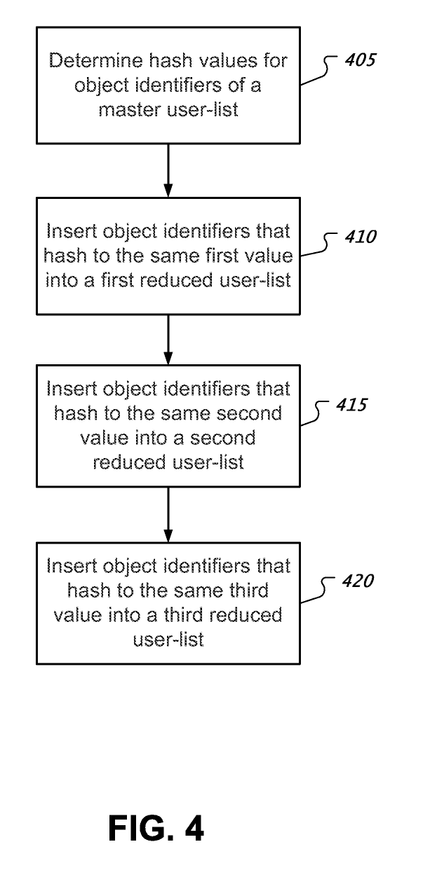

FIG. 4 shows a flowchart of an example process that includes generating different reduced user-lists based on hash values. At 405, the process determines hash values for object identifiers of a master user-list. Determining a hash value can include using a hash function. Various examples of hash functions include ones from the Secure Hash Algorithm (SHA) family, MD5 Message-Digest Algorithm, and a function that outputs the modulus of an input value based on a modulo value. Other hash functions are possible. Determining hash values for the object identifiers, for example, can include calculating a first hash of concatenation of multiple data fields included in an object identifier, and calculating a second hash based on the output of the first hash. In some implementations, determining hash values for the object identifiers can include calculating a hash of a concatenation of multiple data fields included in an object identifier. At 410, the process inserts object identifiers that hash to the same first value into a first reduced user-list. At 415, the process inserts object identifiers that hash to the same second value into a second reduced user-list. At 420, the process inserts object identifiers that hash to the same third value into a third reduced user-list. In some implementations, the process selects one of the reduced user-lists to provide as an output. In some implementations, the process provides all of the reduced user-lists as an output.

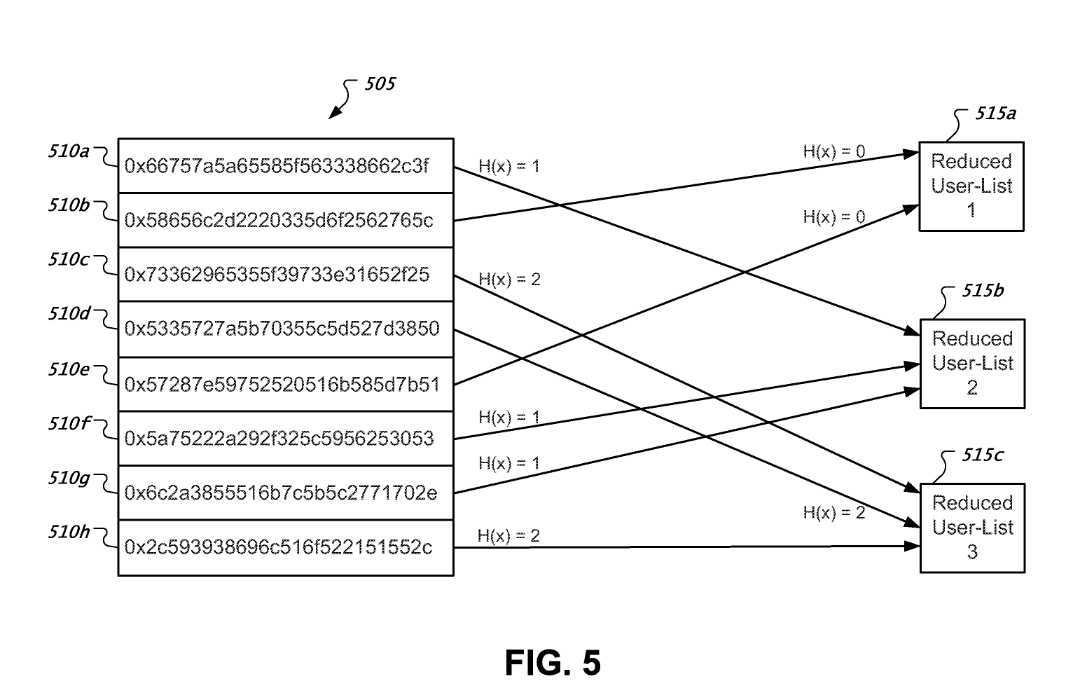

FIG. 5 shows an example of distributing object identifiers from a master user-list into three reduced user-lists. The master user-list 505 includes object identifiers 510a-h. The object identifiers 510a-h have hexadecimal values, as depicted, which correspond to a cookie value of a respective object identifier. A hash function H(x) is used to map an object identifier 510a-h to a reduced user-list 515a-c. In this example, H(x)=x % N, where N=3.

Thus, there are three possible output values of H(x), i.e., 0, 1, or 2. The output values correspond to the reduced user-lists 515a-c, respectively. Object identifiers having H(x)==0 are assigned to the first reduced user-list 515a, object identifiers having H(x)==1 are assigned to the second reduced user-list 515b, and object identifiers having H(x)=2 are assigned to the third reduced user-list 515c.

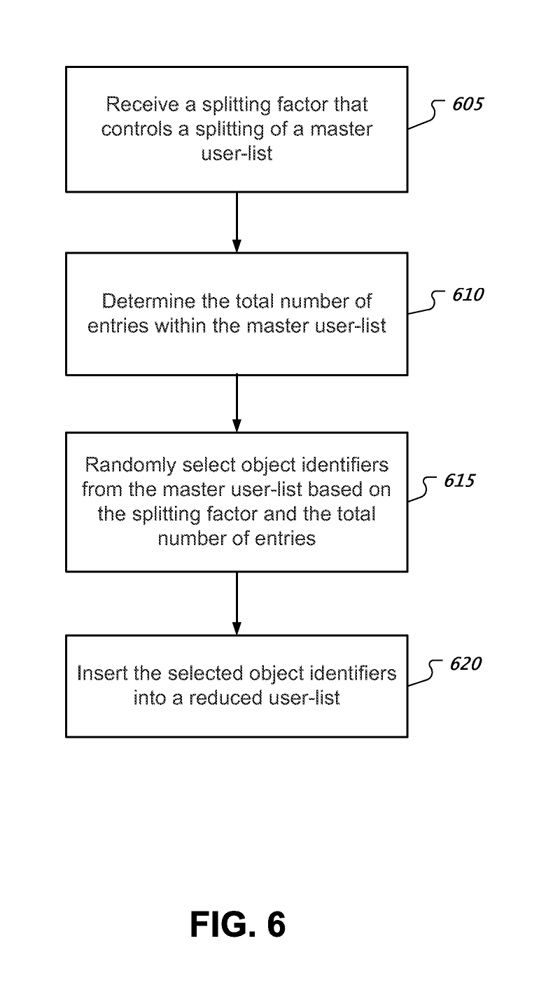

FIG. 6 shows a flowchart of an example process that includes generating a reduced user-list based on random sampling of a master user-list. At 605, the process receives a splitting factor that controls a splitting of a master user-list. Receives a splitting factor can include accessing a value from a file, receiving a value from a network connection, being passed a value via a function call, or a combination thereof. At 610, the process determines the total number of entries within the master user-list. In some implementations, determining the total number of entries includes counting the entries. In some implementations, determining the total number of entries includes accessing a storage device value corresponding to the master user-list (e.g., the master user-list file on storage device consumes 50 megabytes of storage space) and computing the total number based on that value and a known fixed entry size.

At 615, the process randomly selects object identifiers from the master user-list based on the splitting factor and the total number of entries. For example, based on the splitting factor indicating that 25% of the master user-list entries are to be selected, the process can use a result of the selection function to select entries until the total number of selected entries reaches 25% of the master user-list. The selection function can use a random number generator to produce random integer values between 1 and an upper limit (for 25%, the upper limit is 4). Based on the value being equal to a predetermined number (e.g., one), the selection function can return a result that indicates that an entry should be selected. In some implementations, a process can use a pseudorandom number generator in lieu of a random number generator. At 620, the process inserts the selected object identifiers into a reduced user-list. In some implementations, a selected object identifier is included into a reduced user-list file based on a result of a selection function.

An interface for splitting user-lists can provide one or more sampling operators such as a stable split operator or a random split operator. The format for a stable split operator can be STABLE_SPLIT(<Boolean expression>, N, M), where N is a division factor, M represents which part is returned and the expression is the child expression of the SPLIT expression, where M is less than N. In some implementations, a cookie identifier can be used to seed a random sampling function. In some implementations, a cookie identifier is included in an input data object which can be used at evaluation time to perform a pseudorandom splitting. The format for a random split operator can be RANDOM_SPLIT(<Boolean expression>, N), where the operator returns 1/N the original expression by randomly selecting 1/N of cookies where the key for the random number is the time stamp of the evaluation.

Embodiments of the subject matter and the operations described in this document can be implemented in digital electronic circuitry, or in computer software, firmware, or hardware, including the structures disclosed in this document and their structural equivalents, or in combinations of one or more of them. Embodiments of the subject matter described in this document can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this document can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this document can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

Embodiments of the subject matter described in this document can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this document, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method implemented by a data processing apparatus, the method comprising:
obtaining a master user-list, the master user-list comprising object identifiers that are respectively associated with web clients;
obtaining a splitting factor that controls a splitting of the master user-list;
creating a reduced user-list from the master user-list based on the splitting factor such that the reduced user-list maintains a statistical fidelity of the master user-list, the reduced user-list comprising fewer than all of the object identifiers included in the master user-list; and
providing the reduced user-list.

2. The method of claim 1, wherein the master user-list has a statistical distribution of web clients, and wherein the reduced user-list is created to have the same statistical distribution of web clients.

3. The method of claim 1, wherein the splitting factor comprises a value N, wherein creating the reduced user-list from the master user-list comprises:
determining hash values for the object identifiers, the hash values being based on respective values of the object identifiers modulo N; and
using the hash values to select a portion of the object identifiers from the master user-list.

4. The method of claim 1, wherein the splitting factor comprises an integer value K that is greater than one, wherein creating the reduced user-list from the master user-list comprises creating K reduced user-lists based on a division of the object identifiers into K unique portions, wherein the reduced user-lists respectively comprise one of the K unique portions.

5. The method of claim 1, wherein creating the reduced user-list from the master user-list comprises randomly selecting object identifiers from the master user-list based on the splitting factor and a size of the master user-list.

6. The method of claim 1, wherein the object identifiers each comprise a cookie identifier.

7. The method of claim 1, wherein the object identifiers each comprise an identifier based on a hash of a cookie identifier.

8. The method of claim 1, wherein providing the reduced user-list comprises offering the reduced user-list for sale to one or more data buyers.

9. The method of claim 1, wherein obtaining the splitting factor comprises receiving a value via a network, the value being responsive to an input from a data buyer.

10. A computer-readable storage device encoded with a computer program, the program comprising instructions that when executed by data processing apparatus cause the data processing apparatus to perform operations comprising:
obtaining a master user-list, the master user-list comprising object identifiers that are respectively associated with web clients;
obtaining a splitting factor that controls a splitting of the master user-list:
creating a reduced user-list from the master user-list based on the splitting factor such that the reduced user-list maintains a statistical fidelity of the master user-list, the reduced user-list comprising fewer than all of the object identifiers included in the master user-list; and
providing the reduced user-list.

11. The device of claim 10, wherein the master user-list has a statistical distribution of web clients, and wherein the reduced user-list is created to have the same statistical distribution of web clients.

12. The device of claim 10, wherein the splitting factor comprises a value N, wherein creating the reduced user-list from the master user-list comprises:
determining hash values for the object identifiers, the hash values being based on respective values of the object identifiers modulo N; and
using the hash values to select a portion of the object identifiers from the master user-list.

13. The device of claim 10, wherein the splitting factor comprises an integer value K that is greater than one, wherein creating the reduced user-list from the master user-list comprises creating K reduced user-lists based on a division of the object identifiers into K unique portions, wherein the reduced user-lists respectively comprise one of the K unique portions.

14. The device of claim 10, wherein creating the reduced user-list from the master user-list comprises randomly selecting object identifiers from the master user-list based on the splitting factor and a size of the master user-list.

15. The device of claim 10, wherein the object identifiers each comprise a cookie identifier.

16. The device of claim 10, wherein the object identifiers each comprise an identifier based on a hash of a cookie identifier.

17. The device of claim 10, wherein providing the reduced user-list comprises offering the reduced user-list for sale to one or more data buyers.

18. The device of claim 10, wherein obtaining the splitting factor comprises receiving a value via a network, the value being responsive to an input from a data buyer.

19. A system comprising:
a computer-readable storage device that is configured to store a master user-list, the master user-list comprising object identifiers that are respectively associated with web clients; and
a processing device configured to perform operations, the operations comprising (i) obtaining a splitting factor that controls a splitting of the master user-list, (ii) creating a reduced user-list from the master user-list based on the splitting factor such that the reduced user-list is statistically equivalent to the master user-list, the reduced user-list comprising fewer than all of the object identifiers included in the master user-list, and (iii) providing the reduced user-list.

20. The system of claim 19, wherein the master user-list has a statistical distribution of web clients, and wherein the reduced user-list is created to have the same statistical distribution of web clients.

21. The system of claim 19, wherein the splitting factor comprises a value N, wherein creating the reduced user-list from the master user-list comprises:
determining hash values for the object identifiers, the hash values being based on respective values of the object identifiers modulo N; and
using the hash values to select a portion of the object identifiers from the master user-list.

22. The system of claim 19, wherein the splitting factor comprises an integer value K that is greater than one, wherein creating the reduced user-list from the master user-list comprises creating K reduced user-lists based on a division of the object identifiers into K unique portions, wherein the reduced user-lists respectively comprise one of the K unique portions.

23. The system of claim 19, wherein creating the reduced user-list from the master user-list comprises randomly selecting object identifiers from the master user-list based on the splitting factor and a size of the master user-list.

24. The system of claim 19, wherein the object identifiers each comprise a cookie identifier.

25. The system of claim 19, wherein the object identifiers each comprise an identifier based on a hash of a cookie identifier.

26. The system of claim 19, wherein providing the reduced user-list comprises offering the reduced user-list for sale to one or more data buyers.

27. The system of claim 19, wherein obtaining the splitting factor comprises receiving a value via a network, the value being responsive to an input from a data buyer.
